(19) United States
(12) Patent Application Publication
(10) Pub. No.: US 2025/0242303 A1
(43) Pub. Date: Jul. 31, 2025

(54) Method and Device for Selecting at Least One Adsorbent Containing Different Storage Substances as Well as a Computer Program Product

(71) Applicant: Robert Bosch GmbH, Stuttgart (DE)

(72) Inventors: Philipp Nolte, Gerlingen (DE); Helmut Schmidt, Bietigheim Bissingen (DE); Ulrike Mock, Pforzheim (DE); Anne Fuchs, Gerlingen (DE)

(21) Appl. No.: 19/029,848

(22) Filed: Jan. 17, 2025

(30) Foreign Application Priority Data
Jan. 31, 2024 (DE) 10 2024 200 862.1

(51) Int. Cl. B01D 53/62; B01D 53/34; B01D 53/81

(52) U.S. Cl. CPC B01D 53/62; B01D 53/346; B01D 53/81; B01D 2253/20; B01D 2257/504; B01D 2258/06

(57) ABSTRACT

A method includes selecting at least one adsorbent containing different storage substances for the adsorption of sorbents, taking into account both physical and chemical parameters of the different storage substances and taking into account a theoretical and/or data-based adsorption behavior of the different storage substances, the amounts of adsorption of the sorbents based on a plurality of physical data of a carrier medium associated with different points in time and/or periods of time.

This application claims priority under 35 U.S.C. § 119 to application no. DE 10 2024 200 862.1, filed on Jan. 31, 2024 in Germany, the disclosure of which is incorporated herein by reference in its entirety.

### FIELD

The disclosure relates to a method for selecting at least one adsorbent containing different storage substances, which can be used in particular in connection with the removal of CO₂ from the atmosphere and the storage of CO₂ in storage substances. Further, the method relates to a device, in particular to a data processing system for carrying out the method, as well as a computer program product.

### BACKGROUND

As climate change advances, possible approaches are being sought more and more to reduce the increase in CO₂ in the atmosphere or to remove the CO₂ present in the atmosphere and store it in suitable storage media. The calculation methods used for this purpose are typically described by simple sorption models using experimental laboratory data and a constant or fixed temperature. Such computational methods, which are designed to be relatively simplified, appear to have a potential for improvement in terms of their accuracy with regard to the complexity of the processes taking place.

### SUMMARY

The method according to the disclosure for selecting at least one adsorbent containing different storage substances with the features described herein has the advantage that it allows a selection of suitable storage substances for a location using a theoretical and/or data-based adsorption behavior of the storage substances.

The amounts of adsorption are calculated based on realistic physical data of the carrier medium containing the sorbents. In particular, the method according to the disclosure is thus also suitable for selecting the most suitable storage substance for a specific location. The disclosure is based on the idea of determining the amounts of adsorption for different storage substances, taking into account both physical and chemical parameters of the storage substances, wherein physical data of the carrier medium prevailing at different points in time and/or during different time periods is considered, and wherein the physical data comprises at least data on the temperatures of the sorbents, because their temperatures have a substantial influence on adsorption.

Against the background of the above explanations, therefore, a method for selecting at least one adsorbent containing different storage substances for the adsorption of sorbents with the features described herein provides that, taking into account both physical and chemical parameters of the different storage substances as well as taking into account a theoretical and/or data-based adsorption behavior of the different storage substances, the amounts of adsorption of the sorbents are determined based on multiple types of physical data of a carrier medium associated with different points in time and/or periods of time, wherein the physical data comprises at least the temperatures prevailing at the different times and/or periods in time, and preferably the partial pressures of all sorbents of the carrier medium containing the sorbents and which reacts chemically with the different storage substances.

The method according to the disclosure is preferably used to determine the amounts of adsorption of CO₂ as a sorbent, wherein the physical data of the carrier medium is the weather data of a location, and wherein the weather data comprises at least the air temperature, and preferably the air pressure and/or the humidity.

Ranking lists for the various storage substances in question can be created according to certain criteria (e.g., annual averages; (non) uniform usage within a year; differences between day and night operation . . . ). The material can be selected via an automated process along with economic criteria. In principle, parameters to be selected on the system can also be optimized to suit each material or to suit each location.

With respect to weather data, it is possible on the one hand to use historical weather data from weather services. However, additionally or instead of this, forecasted weather data may also be used, which relates in particular to an amount of time that CO₂ storage is to be carried out at a potential location. This may be particularly useful when forecasting future heating/climate changes for a location.

In furtherance of the most recent suggestion, it may be contemplated that weather data evaluated or forecasted at certain times and/or periods may be used to determine the amounts of adsorption. For example, in particular, the amounts of the sorbent adsorbed at different times of year and/or day may be determined and evaluated.

The following explanation is provided with regard to weather data: The data set for the weather at a location can be based on own measurements or databases (e.g., of the German weather service). Ideally, it includes temperature, humidity and air pressure together with a timestamp. If the air pressure is not available, an approximate partial CO₂ pressure which is independent of the weather, e.g. 0.4 mbar, can also be used. If a continuous deviation or a deviation changing over time of the CO₂ content from the natural average is to be assumed at the location, then data from sensors, satellite imagery or modeling data can also be used. If geometry and operating parameters are also known for a CO₂ storage system, for instance, the weather data can additionally be pre-processed, e.g. an increased dynamic pressure at the inlet of the system in calculating the partial CO₂ pressure or an air temperature deviating from the ambient temperature at the location of the sorbent.

At high temperatures and humidity levels (e.g. above 50° C.), in order to obtain particularly precise values for the molar fraction or the amount of material of CO₂ it is recommended to use a dilution factor of the CO₂ by the water content in the air (e.g., an absolute humidity of 4% in the air leads to a reduction of 400 ppm CO₂ to only 400/1.04 ppm). Conversely, to accelerate the calculation this exact step can be omitted. To accelerate the calculation, the model may be accelerated by numeric approximations. For example, the complete model may be provided on a sampling point grid consisting of temperature and humidity with a specific grid design. A numerically simple, fitted model (e.g., 1st-3rd degree polynomial model, machine learning model) may be used for approximation or interpolation between these support points.

To objectively compare the different storage substances, the amounts of adsorption of the storage substances are determined based on the same weather data.

With regard to the calculation of the amounts of adsorption, it is particularly provided in connection with CO₂ as a sorbent that the amounts of adsorption for the sorbents are calculated based on static physics, wherein the proportions for how different possible adsorbents of the storage substances and empty spaces are distributed across uniform receptors are calculated.

If a material still needs to be developed, since it is not yet available, the parameter windows for binding energy/adsorption enthalpies suitable for the observed location can also be limited based on the following considerations:
the effort of laboratory screening materials at different temperatures and humidity levels can be minimized to fewer measurements (only the number necessary to determine binding energies/adsorption enthalpies).
New adsorption materials and/or material modifications, or target values for binding energies/adsorption enthalpies are specified (e.g. for atomistic simulations with structural variation). This may be used to limit whether or not modifications are even promising.

If a material is not yet available (because it still needs to be developed and synthesized), the adsorbents and the binding energies will still be unknown. If certain adsorbents are to be assumed based on known sorbents, however, the binding energy must be saved as a variable. It can be varied between a minimum and maximum value (e.g. −0.05 eV to −1 eV) in a grid (e.g. 0.01 eV).

Starting from the adsorbents of known materials, one or more adsorbents can be artificially excluded in the model for new materials and the binding energy can be used as a variable instead of a fixed parameter for the remaining adsorbents. One or more adsorbents can also be additionally built into the model, e.g. a state with a further H₂O:CO₂ ratio as compared to a known material, as well as with the corresponding binding energies as variables.

Ultimately, such unknown or uncharacterized materials may be formally treated as existing materials if the variants of additional adsorbents are included in the grid of the binding energy parameter windows. The “selected” material is then to be understood in terms of a requirement for adsorbents and binding energies, which a material to be developed should preferably meet.

Furthermore, the method according to the disclosure is used to depict the thermodynamically possible filling state between 0% and 100% of a storage material with CO₂, depending on the ambient temperature and humidity. Kinetic aspects are not considered, so the physical model yields the maximum possible fill level in the favorable case.

In further development of the method just described, it is provided that for each possible adsorbent of the storage substances, the stoichiometry of all involved sorbents is taken into account, the entropy of the receptors is calculated, and the chemical potentials of the storage substance for each adsorbent are linked to the chemical potentials of the gases involved in the process.

It is also envisioned in a further development of the method that sorbents are considered that are chemically bound to more than one receptor of the storage substances.

In a further development of the proposal just described, it may be contemplated that the distances and spatial arrangement of the receptors are grouped together into individual cluster types and that the cluster types are considered as receptors.

It is further explained that the method described herein may be used not only for determining or calculating the storage of CO₂, but also for other substances or sorbents and for other technical equipment in the area of filtering. The method according to the disclosure may also be used for liquid chemical or solutes in liquids.

Furthermore, the disclosure comprises a device, in particular a data processing system configured to perform a method according to the disclosure.

Lastly, the disclosure also comprises a computer program product, in particular a data program or a data storage medium, comprising commands that cause the device to perform at least one of the method steps according to the disclosure.

Further advantages, features, and details of the invention will emerge from the following description of embodiments of the disclosure and from the drawings.

### BRIEF DESCRIPTION OF THE DRAWINGS

FIG. 1 and FIG. 2 show flowcharts to explain possible approaches for selecting suitable storage substances for a location based on weather data,

FIG. 3 depicts an illustration of a thermodynamic model system consisting of a gas phase and a sorbent,

FIG. 4 shows a diagram of CO₂ occupancy of receptors at different assumed binding energies over the temperature profile,

FIG. 5 and FIG. 6 show diagrams of the CO₂ occupancy of the receptors at different binding energies and different partial pressures,

FIG. 7 shows a diagram of occupancy at different partial CO₂ pressures at a defined water vapor partial pressure,

FIG. 8 shows an illustration of different receptors in irregular spatial arrangement that are combined and categorized as clusters; and

FIG. 9a and FIG. 9b show illustrations of successive steps for modeling adsorption when two receptors are involved for formation in one of the adsorbing materials.

### DETAILED DESCRIPTION

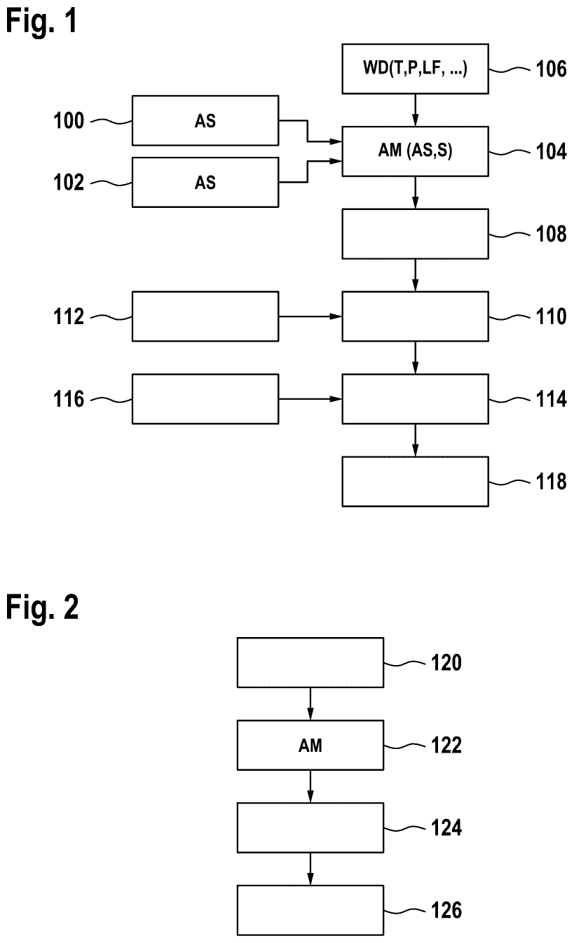

In FIG. 1, a basic method for linking data with respect to determining an amount of adsorption AM of CO₂ as sorbent S in at least one storage substance or adsorbing material AS is shown in conjunction with consideration of weather data WD in the form of a flow chart.

In FIG. 1, block 100 comprises data that takes into account chemical parameters of possible adsorbing materials AS and stoichiometries. Block 102 comprises data for the physical input parameters of possible adsorbing materials AS. The physical input parameters comprise, in particular, binding energies or enthalpies, wherein the input parameters indicated are either known or available as assumed input parameters.

The data from the two blocks 100, 102 are fed to a block 104 as input variables. Block 104 comprises a computer program as part of a data processing system, wherein the computer program comprises an algorithm that enables determination of the amount of the assumption AM as a function of the adsorbing material or materials AS and the sorbents S.

Weather data WD is fed to the block 104 via a block 106 as an input variable. In the context of the invention, weather data WD means weather data WD of a possible (geographical) location LO of a system for storing the sorbents S, in particular for CO₂ storage. The weather data WD may be either historical weather data WD, or forecasted weather data WD (for the future). The weather data WD comprises, for example, in particular over longer periods of time, daily recorded weather data WD over several years comprising at least the air temperature T and the air pressure P. Preferably, the weather data WD also comprises the humidity LF. The air thereby represents a carrier medium for the CO₂ in the atmosphere.

For example, in block 104, the algorithm determines amounts of adsorption AM for each day for which the weather data is available. For example, these amounts of adsorption AM can be summed up for certain periods of time, and average values can be formed or evaluated statistically. This takes place in block 108.

The data obtained in block 108 is then further processed in a block 110. Block 110 is used to agglomerate the determined data using a fixed data filter. To this end, block 110 is provided with data as inputs via block 112 that comprises technical or economic criteria for operating a sorbent in a system for removing CO₂ from the atmosphere.

The data obtained in block 110 may then be further processed in a block 114. Block 114 represents a second data filter and is used for further bundling and evaluation of the data. For this purpose, data is fed to block 114 via a block 116, which serves to evaluate the classification for achieving target values based on technical and economic considerations. The data obtained in block 114 is then illustrated or output in a block 118, wherein a degree of achievement of performance objectives is documented in block 118. The blocks 100 to 118 described above can be realized in the form of a computer program product in the data processing system or on a computer.

FIG. 2 illustrates a method for evaluating or assessing various different storage substances for the same location LO based on the basic method discussed in connection with FIG. 1. The method according to FIG. 2 comprises a block 120 in which the physical and chemical parameters and data known from block 100 and 102 of FIG. 1, and respectively adapted to the different storage substances, is used. Subsequently in a block 122, the amounts of adsorption AM are determined for the various storage substances, s according to block 104 of FIG. 1, in each case based on the same data sets of weather data WD for a location LO. The block 124 represents an output block that contains a level of achievement of performance targets for each material variant. Lastly, a ranking of the different storage materials is generated in a block 126.

In summary, the methods shown in FIG. 1 and FIG. 2 are used to select or compare suitable storage materials for the removal of in particular CO₂ as a sorbent S from the atmosphere serving as a carrier medium.

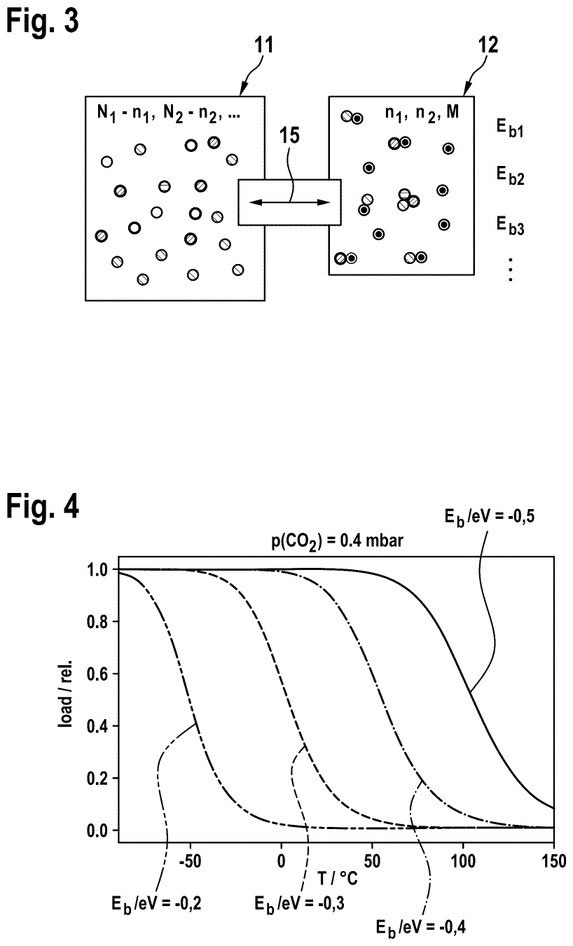

With regard to the determination or calculation of amounts of adsorption AM of sorbents S from the storage substances or the adsorbents AS, respectively, FIG. 3 is initially referred to in the following. In FIG. 3, the stored gas quantity in an adsorbent AS is shown from a thermodynamic point of view. A first sub-system 11 shown on the left side of FIG. 3 depicts the gas phase, which can consist of several gas varieties of different concentrations (e.g. nitrogen, oxygen, CO₂, water). There is a sorbent with the same kinds of receptors in the second sub-system 12 shown on the right side of FIG. 3, wherein the two sub-systems 11, 12 interact, as is illustrated by the double arrow 15. Some of the gases may be attached to each receptor n₁, n₂, etc. However, there are only discrete ways they can be occupied by one or more of the gases. Each variant is referred to as an adsorbent AS. The adsorbent AS is assigned a binding energy E_{b,i} or adsorption enthalpy ΔHᵢ. There may be k different adsorbents AS. Not all gas types need to be involved in adsorbing (e.g. oxygen, nitrogen). The receptors may remain unfilled.

In order to determine the amount of adsorption AM, it is first necessary to clarify which proportion of the receptors is unfilled and which proportion is occupied with the adsorbent types i=1.2, . . . k, namely depending on temperature T and depending on the initial number of all molecules of each gas type in the gas phase. According to the laws of thermodynamics, the equilibrium condition is that the gas molecules must be distributed between the gas phase and the sorbent such that the free energy F=E−TS is minimal. Here, E is the total energy of both sub-systems 11, 12, S is the total entropy of both sub-systems 11, 12. The free energy F may be calculated individually for both sub-systems 11, 12 and equated to the particle flow direction taking into account the signs.

If there is a large gas reservoir with a practically fixed concentration (despite adsorption), it is practical to use Gibbs free energy G (pi, T)=F+pV and to calculate using concentrations of the gases rather than particle numbers. If a volume change is neglected for the sorbent (at least a volume increase will be significantly lower than the volume the ab/adsorbed sorbent S would have taken up in a gas form), then no further differentiation between free energy and Gibbs free energy must be considered for it in the equations.

As the equilibrium condition, the derivation of F (or G) must be equated with the corresponding negative derivatives regarding the gases (left sub-system 11) in relation to all adsorbents AS in the sorbent (right sub-system 12). In addition, stoichiometric coefficients must be considered, because not every adsorbent AS must be composed of exactly one substance.

Using the example of two gases A and B and k different adsorbents AS, a system of k reaction equations results.

$${v}_{1 A} \cdot A + {v}_{1 B} \cdot B + Recept ⇌ {Adsorbent}_{1} , \\ enthalpy of Δ {H}_{1} ( T ) or binding energy - {E}_{b 1} \qquad ( 1 )$$

$${v}_{2 A} \cdot A + {v}_{2 B} \cdot B + Recept ⇌ {Adsorbent}_{2} , \\ enthalpy of Δ {H}_{2} ( T ) or binding energy - {E}_{b 2} \qquad ( 2 )$$

$$⋮$$

$${v}_{kA} \cdot A + {v}_{kB} \cdot B + Recept ⇌ {Adsorbent}_{k} , \\ enthalpy of Δ {H}_{k} ( T ) or binding energy - {E}_{b k} . \qquad ( k )$$

In the sorbent, the energy can be balanced as a weighted sum of all binding energy with the respective occupations: E_{sorb}=−m₁·E₁−m₂·E₂ . . . −mₖ·Eₖ The entropy can be calculated via S_{sorb}=k_{B}. ln(Ω). In this respect, kg is the Boltzmann constant and Ω is the number of possible micro-states that an occupancy with m₁, m₂, . . . mₖ adsorbents AS of types 1, 2, . . . k can fulfill. The number of unoccupied receptors is necessarily determined to be (M−m₁−m₂ . . . mₖ):

$$Ω ( M , {m}_{1} , ... , {m}_{k} ) = \frac{M !}{{m}_{1} ! {m}_{2} ! ... {m}_{k} ! ( M - {m}_{1} - {m}_{2} ... - {m}_{k} ) !}$$

The k chemical potentials of adsorbents AS are derived from the partial derivatives of the free energy/Gibbs free energy of the sub-system of the sorbent according to m₁, m₂, . . . mx. These must be linked to the derivatives of the free energy of the gases (or the chemical potentials) of the gases. The stoichiometric factors vᵢⱼ must be taken into account. The temperature-dependent chemical potentials of the gases can be determined from the relevant literature tables for gases. If the gases do not behave ideally, these properties are in the referenced chemical potentials.

Finally, from the k equations, the relative fraction αᵢ=m√M at the receptors can be determined for each adsorbent AS and the empty spaces if the gas concentrations and the temperatures T are known.

FIG. 4 shows a diagram with a first example of an ideal selective sorbent that binds only one gas type (here: CO₂) and no further gas, wherein exactly one CO₂ molecule is bound per receptor. There is competition between occupied receptors and non-occupied receptors. The temperature profiles of the relative CO₂ occupancy (load/rel.) of the receptors are overlaid in FIG. 4, namely for a partial CO₂ pressure of 0.4 mbar (corresponding to 400 ppm at 1 bar total pressure) at different assumed binding energy levels (B_{b}/eV). At high and low temperatures T, the curves approach asymptotically horizontal lines and show a sharp slope in a transition region that has a nearly linear curve with temperature T between approximately 20% and 80%. These slopes change slightly with the binding energy B_{b}/eV and they become flatter the weaker the binding energy B_{b}/eV is.

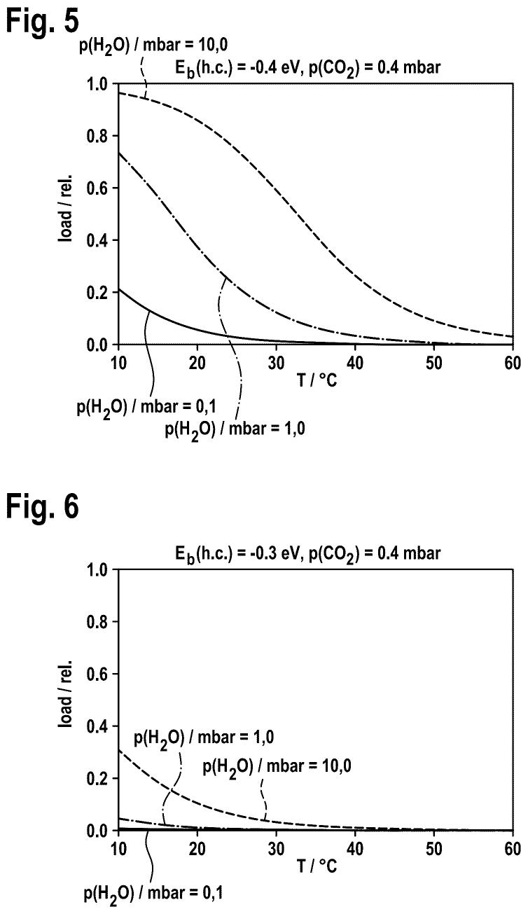

FIGS. 5 and 6, as a second example, show a further ideal selective sorbent that binds exactly one composite adsorbent per formulation, consisting of one H₂O molecule and on CO₂ molecule. The upper and lower diagrams differ by the binding energy of −0.4 eV and −0.3 eV, respectively. In each of the diagrams, three different partial pressures of water vapor are recorded, at a fixed partial pressure CO₂ (0.4 mbar). It can be seen here that the occupancy (load/rel.) also depends heavily on the partial water pressure.

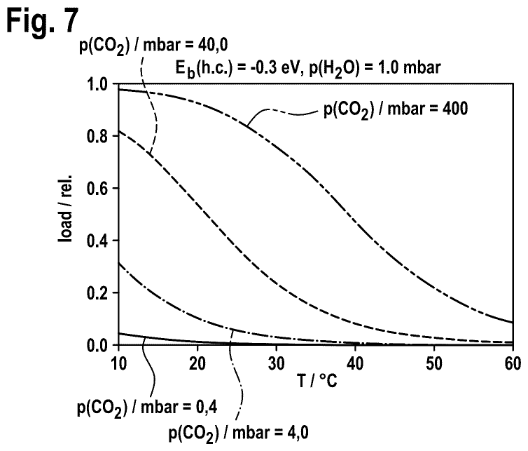

FIG. 7 shows, in a complementary manner, how occupancy (load/rel.) at a fixed partial water pressure changes with temperature T when there are different partial CO₂ pressures. This corresponds qualitatively to a law of mass action (shift of the equilibrium by increasing the concentration of at least one reaction partner).

The particularities of the adsorption processes and the resulting equations of the model described to this extent compared to conventional chemical reactions together with the law of mass action are the non-monotonic process of entropy depending on the occupancy of the sorbent:
a sorbent completely occupied by an adsorbent type and a completely empty sorbent each have an entropy of zero (there is only one microstate corresponding to the macrostate)
the state for maximum entropy in the sorbent is in the uniform distribution of all adsorbents AS with mᵢ=M/k and αᵢ=1/k, respectively.
the derivation of the entropy after occupancy becomes infinitely positive/negative at the edges of the calculated occupancies (limit value considerations mᵢ→0 or mᵢ→M). The sorbent resists exactly complete loading/emptying much more than a partially filled sorbent. Therefore, isobars at very low and very high temperatures T will be horizontal and will have a steep gradient in a temperature window of only a few tens of Kelvins.

With the same formalism, transitional conditions or internal degrees of freedom (e.g. vibrations of an adsorbed molecule group) can also be easily integrated if this state differs from the base level by an energy amount ΔE. Any such additional state may be formally considered as another (k+1)th adsorbent AS by using the same stoichiometry coefficients as for the base state but with an ΔE attenuated binding energy

$$- {E}_{b \_ k + 1} = - {E}_{b \_ k} Δ E .$$

The model from the last section does not yet cover all cases as known for CO₂ adsorption on amines, despite its generality. The adsorbent AS “ammonium carbamate” may also be formed on primary amines. A CO₂ molecule is thereby taken up at two adjacent amine groups (receptors), whereby the distances between the amine groups may not be too great in this case. For thermodynamic modeling, the assumption from the final section (all receptors are the same type) must be modified. It is necessary to take into account the additional spatial proximity of the receptors to one other.

In the following, the case is considered that only the two adsorbents AS “hydronium carbamate” and “ammonium carbamate” can form in competition with each other and in competition with unfilled receptors.

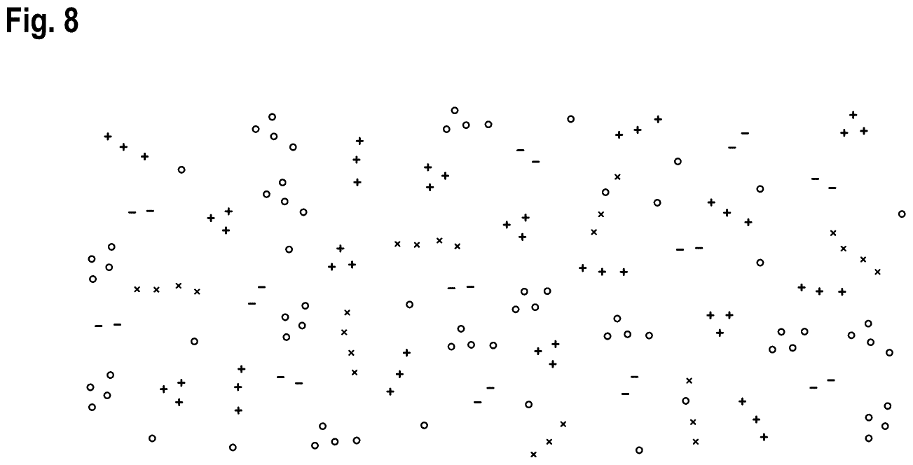

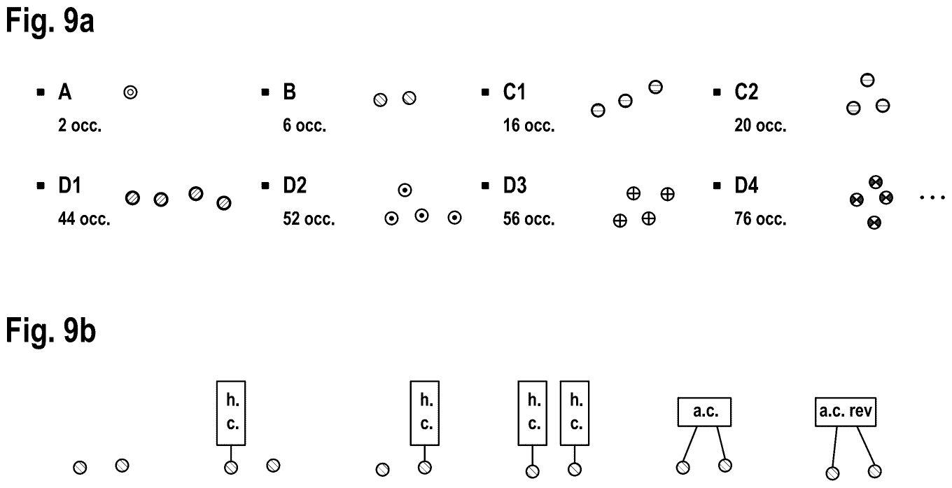

FIG. 8 shows the combining of receptors in clusters. In a single cluster, adjacent receptors are combined when the distances between them are compatible with pairwise adsorption. A cluster may consist of 1, 2, 3, . . . receptor objects. The single, isolated receptor (type A) is a special case if there is no neighbor for pair formation; no ammonium carbamate formation can take place on it, only a hydronium carbamate formation or maintaining the empty position. However, the number of receptors in a cluster is not sufficient for categorization, as shown in FIG. 9a. For example, if there are three or more receptors in a cluster, the receptors can be arranged as a chain, as a triangle, or as a pyramid, for which categories must be defined (C₁, C₂) in each case.

The total sorbent can thus be modeled as a weighted sum of the individual cluster categories. If no further details are known about the structure of the sorbent, then in practice models for different cluster frequencies are calculated and the weightings must be determined as fit parameters.

It is particularly advantageous that the same calculation method as for a single receptor can be used for each cluster category. To do so, formally all of the adsorbent configurations must be considered to be another adsorbent AS having its own binding energy. This is shown using the example of cluster type B in FIG. 9b. All contemplated combinations of how empty spaces and adsorbents AS could be distributed are considered: hydronium carbamate (occupies a receptor with H₂O+CO₂) and ammonium carbamate (occupies two receptors with a CO₂), wherein a mirror asymmetry (a.c. rev) was also taken into account). For cluster type B, there are six adsorption configurations. The competition from these six adsorption configurations is calculated according to the formalism from the last section for p(CO₂), p(H₂O) and temperature T, wherein the stoichiometries for H₂O and CO₂ are considered. If the proportions of the individual occupancies α₀ to α₅ are known, then the equivalents for ammonium carbamate, hydronium carbamate and H₂O and CO₂ equivalents can be balanced as the overall average in further steps.

However, when establishing a cluster model, it must be noted that the quantity of all contemplated cluster adsorbent occupancies rapidly increases with the number of individual receptors. While there are only six configurations for type “B” (referred to as “occ.” in FIG. 9a), there can already be forty-four to seventy-six configurations for the clusters having four receptors (types “D₁” to “D₄”) (=formal adsorbents AS). Simulations have shown that different cluster types can also demonstrate similar behaviors. It may be sufficient to limit oneself to a small number of cluster types and use fewer weighting factors (to be determined from experiments) for this purpose.

In addition, it is mentioned that it is additionally conceivable to combine the theoretical model of loading, which is calculable as described in a fine grid, with a data-driven model of the reaction rates.

The method described thus far can be altered or modified in many ways without deviating from the idea of the invention.

1. A method comprising:
selecting at least one adsorbent containing different storage substances for adsorption of sorbents by:
taking into account both physical and chemical parameters of the different storage substances and taking into account a theoretical and/or data-based adsorption behavior of the different storage substances;
determining amounts of adsorption of the sorbents based on a plurality of physical data of a carrier medium associated with different points in time and/or periods of time, wherein the physical data comprises at least temperatures prevailing at different times and/or periods of time; and
selecting the storage substance as a function of the determined amounts of adsorption of the sorbents.

2. The method according to claim 1, wherein the physical data further comprises partial pressures of all sorbents of the carrier medium containing the sorbents and which chemically reacts with the different storage substances.

3. The method according to claim 1, wherein:
the determining the amounts of adsorption includes determining amounts of adsorption of CO₂ as one of the sorbents,
the physical data of the carrier medium is weather data of a location, and
the weather data comprises at least an air temperature.

4. The method according to claim 3, wherein the weather data further comprises humidity and/or air pressure.

5. The method according to claim 3, wherein the weather data is historical weather data and/or forecasted weather data.

6. The method according to claim 5, wherein the weather data evaluated or forecasted at certain times and/or time periods is used to determine the amounts of adsorption of the storage substances.

7. The method according to claim 3, wherein the same weather data is used for all storage substances to compare the storage substances with regard to amounts of adsorption.

8. The method according to claim 1, wherein the amounts of adsorption of the sorbents are calculated based on statistical physics, and proportions by which different possible adsorbents of the storage substances and empty spaces are distributed on similar receptors are calculated.

9. The method according to claim 8, wherein, for each possible adsorbent of the storage substances, stoichiometry of all involved sorbents is considered, entropy of the receptors calculated, and chemical potentials of the storage substances for each adsorbent are linked to the chemical potentials of gases involved in the process.

10. The method according to claim 1, wherein sorbents are attached to more than one receptor of the storage substances.

11. The method according to claim 10, wherein distances and spatial arrangement of the receptors are combined into individual cluster types and the cluster types are considered as receptors for determining the amounts of adsorption.

12. A device comprising:
a data processing system configured to perform the method according to claim 1.

13. A computer program product comprising:
a data program or data storage medium comprising commands that cause the device of claim 12 to perform the selecting of the at least one adsorbent containing different storage substances for the adsorption of sorbents.
